(19) United States
(12) Patent Application Publication
(10) Pub. No.: US 2004/0256761 A1
(43) Pub. Date: Dec. 23, 2004

(54) Method of and apparatus for producing a reclosable pouch

(76) Inventor: James C. Pawloski, Bay City, MI (US)

Correspondence Address: S.C. JOHNSON & SON, INC., 1525 HOWE STREET, RACINE, WI, 53403-2236, US

(21) Appl. No.: 10/463,171

(22) Filed: Jun. 17, 2003

(51) Int. Cl. B29C 47/06

(52) U.S. Cl. 264/167; 264/171.13; 264/173.16; 425/133.5; 425/363; 425/382.3

(57) ABSTRACT

According to one aspect of the present invention, a method of preparing a film for use in forming a storage bag comprises the steps of: supplying a pre-extruded thermoplastic film, the film having opposite first and second edge portions; extruding a first base onto the first edge, wherein the first base partially overlaps the first edge; and extruding a first profile onto the first base.

### TECHNICAL FIELD

The present invention relates generally to reclosable pouches, and more particularly, to a method of and apparatus for manufacturing a thermoplastic storage bag.

### BACKGROUND ART

The use of reclosable thermoplastic bags for the storage of household items, such as food or other articles, is well known. An example of a reclosable thermoplastic bag is disclosed in Ausnit, U.S. Pat. No. 5,259,904. The plastic bag includes thermoplastic bag walls of consistent thickness throughout. A closure profile comprised of male and female closure profile portions are disposed on internal portions of the bag walls. Two opposing lips with grip strips are disposed directly above the closure profiles. A user may place an item in the bag, interlock the closure profiles to close the bag, and re-open the bag using the grip strips to disengage the closure profiles.

There are several methods for manufacturing such reclosable thermoplastic bags. Known processes include the blown method, the cast integral method, and the cast post applied method. Bags manufactured by one of these methods may have characteristics that are different than bags made by another of these methods. Also, the production speeds are different and the costs associated with the methods vary widely.

The blown method is a two-up process that extrudes a cylindrical bag web of a single thickness simultaneously and integrally with two male and two female closure profiles. The two male profiles are disposed adjacent one another on an inside surface of the cylindrical bag web and the two female profiles are disposed adjacent one another on the inside surface of the web diametrically opposite the male profiles. As the bag web is extruded, air is blown into the interior thereof so that the thermoplastic is cooled. Thereafter, the bag web is slit between adjacent male and female closure profiles to form two web portions. The profiles of each web portion are then interlocked and the web portions are simultaneously severed and sealed at spaced locations by a hot wire resulting in individual reclosable thermoplastic bags. The production speed of the blown method is relatively slow as compared to other bag-making processes owing to the fact that the blown method utilizes convective cooling as opposed to conductive cooling. A bag manufactured by this method includes a bag web with a relatively uniform thickness throughout and, typically, lips of equal lengths. Any variation in the lip length or lip offset can be difficult to control using this manufacturing method.

The cast integral method includes the step of using a flat extrusion die to extrude the bag web and male and female closure profiles together in an integral fashion directly onto a temperature-controlled driven casting roll. The production speed of the cast integral process is approximately twice the speed of the blown method and the bag web extruded by the cast integral method is typically of a uniform thickness. However, because the profiles are extruded at the same time as the bag web and the profiles are located at the edges of the bag web, neck-in of the extrudate complicates the correct formation of the profiles.

The cast post applied method includes the steps of using a first extrusion die to extrude the bag web onto a casting roll and using one or more additional extrusion dies or other apparatus to extrude or adhere the closure profiles onto the bag web when the bag web is disposed at a location substantially downstream of the casting roll. An example of this method is disclosed in Geiger et al., U.S. Pat. No. 4,755,248. This method has the advantage of being operable at a production speed that is higher than the other two methods. In addition, the method can be used to produce bags having readily controllable portion dimensions and thicknesses.

It has been found that consumers prefer a bag having relatively thick top portions, even where a relatively high force is required to close the closure profiles of the bag, as compared with a bag having uniform wall thickness and a relatively lower required closing force. Also, it has been found that the cost required to change over a cast integral production line to a cast post applied production line (which is the typical manner in which a cast post applied line is implemented) is extremely high due to the implementation cost of the required additional hardware components. An example of thickened top portions is seen in Zieke et al, U.S. Pat. No. 4,471,789. The apparatus and method described in this patent include the use of a single base layer completely overlapping the bag film combined with the use of a rib for guiding the fingers of a user on either side of a closure profile extruded on the base.

### SUMMARY OF THE INVENTION

According to one aspect of the present invention, a method of preparing a film for use in forming a storage bag comprises the step of supplying a pre-extruded thermoplastic film, wherein the film includes opposite first and second edge portions. The method further includes the steps of extruding a first base onto the first edge, wherein the first base partially overlaps the first edge and extruding a first profile onto the first base.

According to another aspect of the present invention, a method of preparing a film for use in forming a storage bag comprises the steps of supplying a film having opposite first and second edges onto a casting roll and extruding a first base member onto the film, wherein the first base member partially overlaps the first edge of the film. The method further includes the steps of extruding a second base member onto the film, wherein the second base member partially overlaps the second edge of the film, extruding a male closure profile onto the first base member, and extruding a female closure profile onto the second base member.

According to yet another aspect of the present invention, a storage bag is produced by a method comprising the step of supplying a film onto a casting roll, wherein the film includes opposite first and second edges. The method further includes the step of forming first and second bases onto the casting roll while the film is in contact with the casting roll, wherein the first and second bases partially overlap the first and second edges, respectively. Still further, the method includes the steps of forming first and second closure profiles on the first and second bases, respectively, while the bases and film are in contact with the casting roll and converting the film into individual storage bags.

In accordance with a still further aspect of the present invention, an apparatus for producing thermoplastic storage bags comprises a casting roll and feed assembly for supplying a bag film to the casting roll. The apparatus further includes an extrusion apparatus for extruding a pair of bases partially overlapping the film on the casting roll, wherein the extrusion apparatus further extrudes a closure profile onto the bases while the bases are on the casting roll.

Still further in accordance with another aspect of the present invention, a method of producing zipper tape comprises the step of extruding first and second bases onto a casting roll, wherein the bases include a central thickened portion, a lip portion extending from one side of the central portion and being thinner than the central portion, and a gripping portion extending from the side of the central portion opposite the lip portion. The gripping portion includes a plurality of gripping ribs extending from a side of the gripping portion opposite the casting roll. The method further includes the step of extruding male and female closure profiles onto the central portions of the first and second bases respectively while the bases are in contact with the casting roll.

Other aspects and advantages of the present invention will become apparent upon consideration of the following detailed description.

### BRIEF DESCRIPTION OF THE DRAWINGS

FIG. 1 is an elevational view of a reclosable thermoplastic storage bag made by the process and apparatus of the present invention;

FIG. 2 is an enlarged, fragmentary, sectional view taken generally along the lines 2-2 of FIG. 1;

FIG. 3 is an isometric view of a first embodiment of the apparatus of the present invention;

FIG. 4 is a side view of the embodiment of FIG. 3;

FIG. 4a is a side view of an alternative embodiment of the present invention;

FIG. 4b is a side view of another alternative embodiment of the present invention;

FIG. 5 is an enlarged fragmentary view of the base die of FIG. 3;

FIG. 6 is a bottom elevational view of an extrusion die profile plate used in the base die of the embodiments of FIGS. 3 and 7; and

FIG. 7 is an isometric view of another embodiment of the apparatus of the present invention.

### DESCRIPTION OF THE PREFERRED EMBODIMENTS

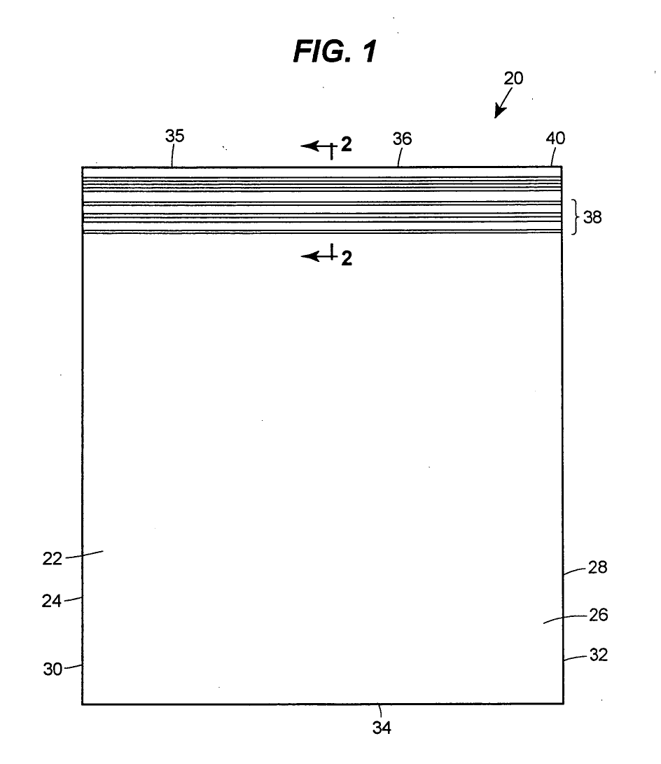

Referring to FIG. 1, a reclosable pouch in the form of a thermoplastic storage bag 20 comprises first and second body portions 22, 24 joined to one another to form first and second bag walls 26, 28. The first and second bag walls 26, 28 are joined at first and second side portions 30, 32, respectively, and at a bottom portion 34. An opening 35 is disposed at a top portion 36 of the bag 20. A closure mechanism 38 and two lips 40 are also disposed at the top portion 36 of the bag 20.

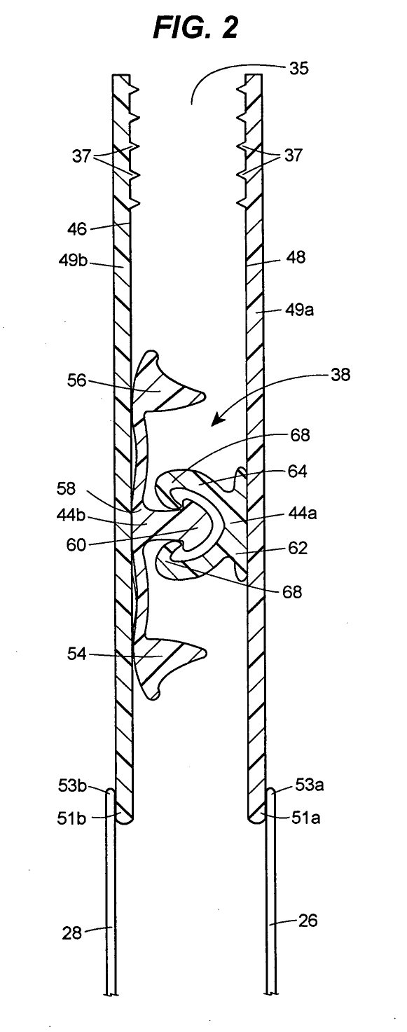

Referring to FIG. 2, female and male closure elements 44a, 44b of the closure mechanism 38 are disposed on opposing inside surfaces 46, 48 of the first and second base portions 49a, 49b, respectively. First and second end portions 51a, 51b of the first and second base portions 49a, 49b, respectively, are attached to and overlap first and second top portions 53a, 53b of the first and second bag walls 26, 28, respectively. Each of the inside surfaces 46, 48 further includes a plurality of gripping ribs 37 located near the opening 35 of the bag 20. However, the number of gripping ribs 37 may vary and can range from none to six or more on each first and second base portions 49a, 49b.

The male closure element 44b comprises a base 58 integral with flanking side members 54 and 56 and an arrow-shaped male engagement member 60 that extends from the base 58. The female element 44a comprises a base 62 with a C-shaped female profile member 64 extending therefrom, wherein the female element 44a is adapted to receive the male element 44b when pressure is exerted on the closure elements by a user's finger(s) during closing of the bag. The side members 54 and 56 are of a sufficient size and proximity to the male engagement member 60 such that the side members 54 and 56 move together with the male engagement member 60 when the male engagement member 60 and female profile member 64 are engaged and disengaged. The side members 54 and 56 also have a height which is less than the height of the male engagement member 60, and the members 54 and 56 extend beyond tips 68 of the female profile member 64 when the male engagement member 60 is engaged with the female profile member 64. Thus, at such time, the tips 68 of the female profile member 64 reside between the side members 54 and 56 and the male engagement member 60. However, this is simply one preferable design of a male/female profile pair, any design know in the art could be utilized and still be within the scope of this invention.

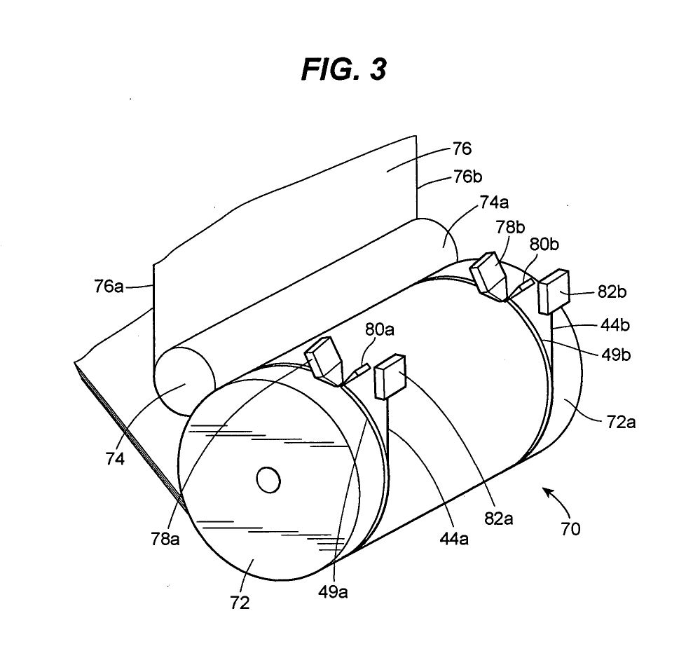

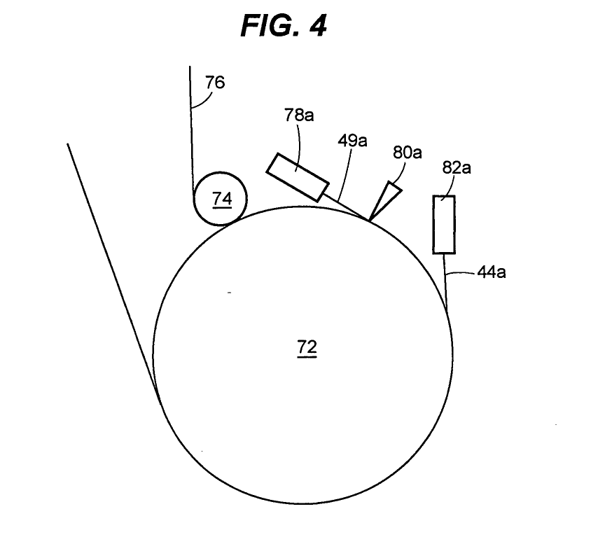

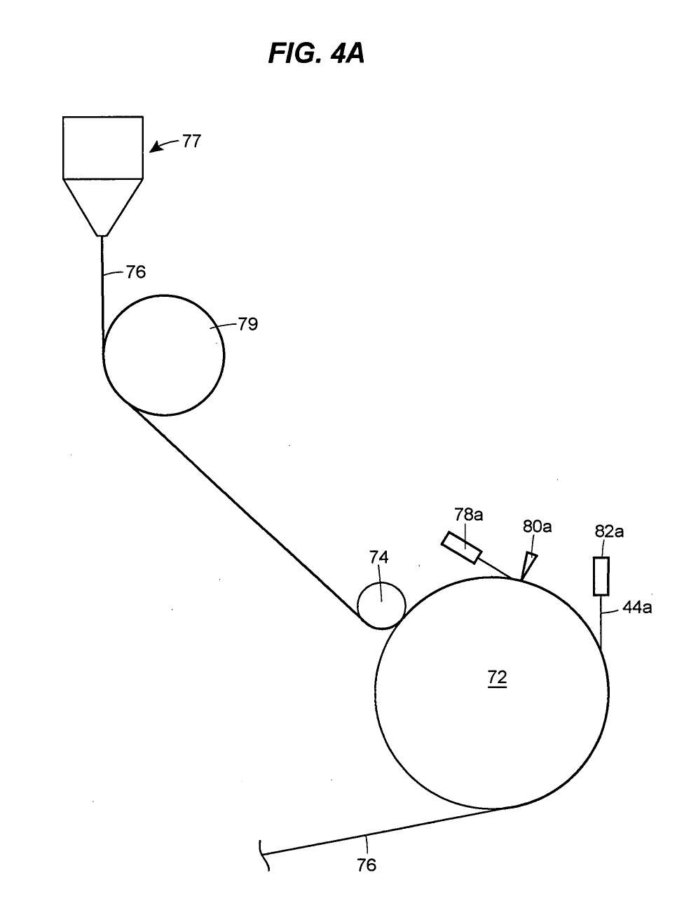

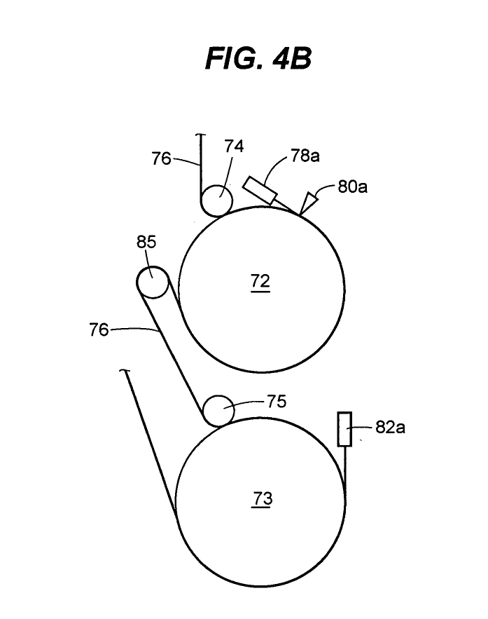

Referring now to FIGS. 3 and 4, an apparatus 70 for producing thermoplastic bags at a high speed includes a rotating and preferably driven casting roller 72 preferably in contact with a rotating secondary rotating roller 74. Alternatively, the casting roller 72 may be idle, in which case, the film 76 is pulled by another driven roller (not shown) further downstream. The film web or film 76 is preferably fed from a roll (not shown) into contact with the secondary roller 74, the film 76 is wrapped around an outer surface 74a of the secondary roller 74, and is thereafter drawn between the casting roller 72 and the secondary roller 74, the driving rotation of the casting roller 72 pulling the film 76. As the film 76 is drawn between the casting roller 72 and the secondary roller the casting roller 72 and secondary roller 74 may not contact each other; rather the casting roller 72 and secondary roller 74 are simply in close proximity with each other. In another alternative, shown in FIG. 4a the film 76 may come from a film extruder 77 disposed upstream from the casting roller 72. In such an embodiment the film 76 is extruded onto a third roller 79 which helps to form the film 76 and direct the film 76 to the secondary roller 74. As would be known by one of skill in the art this process may include further steps, such as cutting off the edges of the film 76 after extrusion but prior to contact with the secondary roller. Also, the film in such a process could be produced via a cast rather than extrusion process. In yet other alternative embodiments, the process may include another roller (not shown) further downstream from the casting roller 72 where chilling of the film 76, bases 49a, 49b and profiles 44a, 44b occurs.

The apparatus 70 further includes first and second base extrusion dies 78a, 78b disposed to extrude the bases 49a, 49b in a position that allows the bases 49a, 49b to overlap edges 76a, 76b of the film 76 by approximately 0.125 inch (3.175 mm). In an alterative embodiment (not shown), the apparatus 70, may include only one extrusion base die 78a or 78b. In such an embodiment, the apparatus would be used to prepare a film 76 that would be combined with another such film 76 to create a storage bag or used to create a storage bag with only one of the profiles disposed on a base. The apparatus 70 further includes pinning air knives 80a, 80b positioned to pin the bases 49a, 49b to the film 76 and blow a jet of air onto the freshly extruded bases 49a, 49b, thus beginning the cooling process. In particular, the pinning air jets 80a, 80b are directed onto the portion of the bases 49a, 49b overlapping the film 76. Alternatively, the air knives 80a, 80b could be replaced by water jets (not shown) to pin the bases 49a, 49b to the film 76 and begin the cooling process. In another alternative, the air knives 80a, 80b could be replaced by shaped rollers (not shown) that rotate and pin the bases 49a, 49b to the film 76. The apparatus 70 further includes profile extrusion dies 82a, 82b disposed adjacent the air jets 80a, 80b to extrude the profiles 44a, 44b onto the bases 49a, 49b, respectively. In an alternative configuration (not shown), each pair of base extrusion dies 49a, 49b and/or profile extrusion dies 44a, 44b could be combined into a single die wherein the bases and/or profiles could be extruded as one combined piece and then cut apart or could be extruded as two separate pieces from the same die.

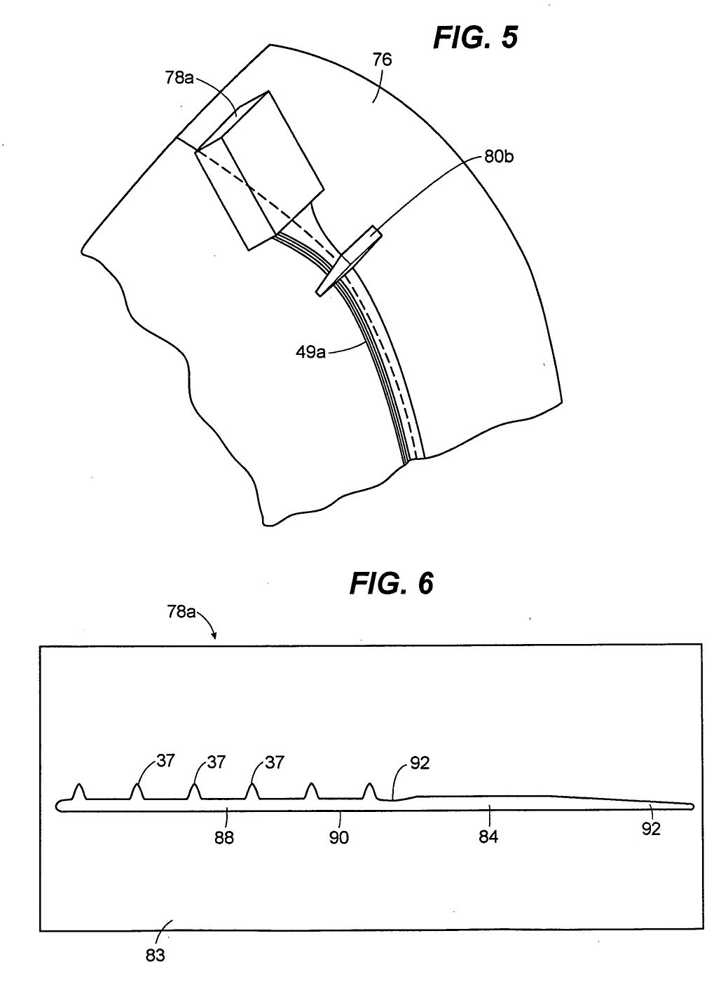

The method of operation of the apparatus 70 includes the steps of feeding molten polymer to the base extrusion dies 78a, 78b and profile extrusion dies 82a, 82b by way of an extruder or melt pump. As the casting roll 72 rotates, the film 76, as shown in FIG. 5, is fed under the base extrusion dies 78a, 78b and the bases 49a, 49b are extruded onto the casting roller 72 and film 76 with an overlap of approximately 0.125 inch (3.175 mm) where the bases 49a, 49b are laid over the film 76. The bases are preferably between about 0.25 inch (6.35 mm) and 2.00 inches (50.8 mm), and most preferably about 1.00 inch (25.4 mm). The overlap between the film 76 and the bases 49a, 49b is also variable in this invention, and can range, with, for example a 1.00 inch (25.4 mm) wide base, preferably between about 0.0625 inch (1.5875 mm) to 0.9375 inches (23.813 mm), and most preferably about 0.125 inch (3.175 mm). However also, it has been found that arranging the overlap so that the film 76 is under the portion of the bases 49a, 49b where the profiles 44a, 44b are attached, discussed below, also provides a bag with acceptable strength and bonding. The amount of overlap varies based upon the width of the bases 49a, 49b, but the only controlling factors in the variation are that the overlap is only partial and not complete and that the overlap is enough to ensure a bond between the bases 49a, 49b and the film 76 during use as a storage bag.

Referring again to FIGS. 3-5 the method thereafter includes the step of pinning the overlapping portion of the bases 49a, 49b to the film 76. Since the bases 49a, 49b are extruded in a molten form the heat from the cooling of the base 49a, 49b will begin the bonding process between the base 49a, 49b and the film 76 once contact is made. In order to encourage the bonding process, the air jets 80a, 80b shoot a stream of air onto the bases 49a, 49b pushing them onto the film and increasing the bonding therebetween. Thereafter, the profiles 44a, 44b are extruded from the profile extrusion dies 82a, 82b onto the central portions 84 of the bases 49a, 49b. Because of the molten nature of the profiles 44a, 44b when extruded, the profiles 44a, 44b are bonded with the still semi-molten bases 49a, 49b by contact therewith. The combined film 76, bases 49a, 49b, and profiles 44a, 44b are then cooled as they continue around the casting roller 72 and are thereafter removed and processed into bags by means known in the art. Alternatively, the casting roller 72 may be temperature controlled to allow further chilling after the extrusion of the profiles 44a, 44b and bases 49a, 49b. Also alternatively, as noted above, such chilling or cooling of the film 76, bases 49a, 49b and profiles 44a, 44b may take place on an additional roller (not shown).

An alternative roller setup and method is shown in FIG. 4b. This embodiment includes a first casting roller 72 and a second casting roller 73. Preferably, the first casting roller is driven, however both or neither of the casting roller 72, 73 may be driven. This embodiment further includes first secondary roller 74 and second secondary roller 75 associated with the first casting roller 72 and second casting roller 73 respectively. The optional last roller in such an embodiment is a transfer roller 85 that is disposed downstream of the first casting roller 72 and upstream of the second casting roller 73 in order to direct the film 76 between the first and second casting rollers 72, 73. The base extrusion dies 78a, 78b and pinning jets 80a, 80b are associated with the first casting roller 72 while the profile extrusion dies 82a, 82b are associated with the second casting roller 73. Therefore, in use the bases 49a, 49b are applied to the film 76 on the first casting roller 72, the film 76 and bases 49a, 49b combined are then transferred to the second casting roller 73 where the profiles 44a, 44b are applied.

Referring now to FIG. 6, an enlarged view of an extrusion die profile plate 83 of one of the base dies 78a is shown. The extrusion die profile plate 83 defines three primary areas that correspond to three areas of the base 49a: a thickened central portion 84, an overlap portion 86 extending from a first end of the central portion 84, and a gripping portion 88 extending from a second end of the central portion 84 opposite the overlap portion 86. The three portions 84, 86, 88 are integral with each other and form a flat bottom side 90 and a top side 92. The top side 92 of the gripping portion 88 includes a plurality of optional gripping ribs 37 extending outwardly from the top side 92. The thickened central portion 86 is thicker than the other portions to accept the extruded profiles 44a, 44b thereon and the overlap portion 86 is thinner than the other portions to facilitate attachment of base 49a to the film 76. This however, is simply one embodiment of the base die 78. Other embodiments may include none or one of the gripping ribs 78, and/or the central portion 84 may be the same thickness as other portions 86, 88 as seen in the base shown in FIG. 2, and/or the overlap portion 86 may be the same thickness as the other portions 84, 88.

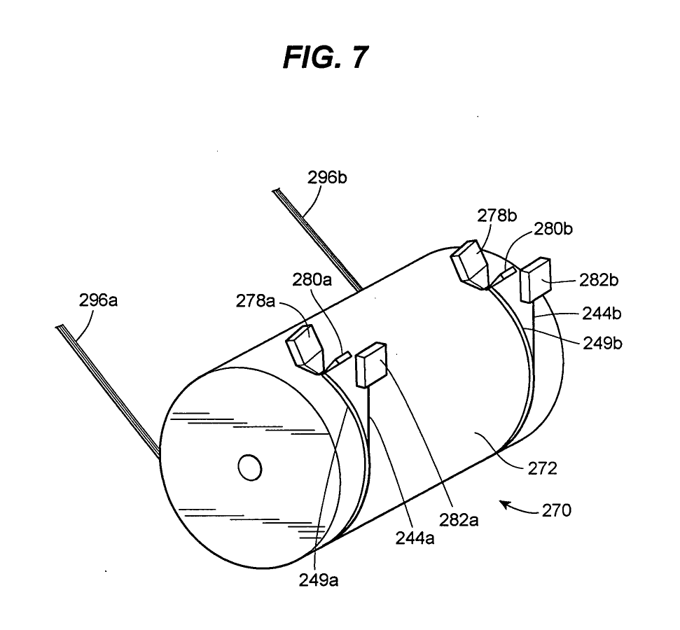

Referring now to FIG. 7, an apparatus 270 for forming zipper tape is shown. The apparatus 270 is similar to the apparatus 70 described in relation to FIGS. 3-5, except that the secondary roller 74 and the film 76 are omitted. The bases 249a, 249b are extruded from the base extrusion dies 278a, 278b onto the casting roller 272. The base extrusion dies 278a, 278b are identical to the extrusion base die pictured in FIG. 6. The air jets 280a, 280b are positioned to pin the bases 249a, 249b onto the casting roller 272 whereby the bases 249a, 249b are positioned to receive the profiles 244a, 244b from the profile extrusion dies 282a, 282b. Once the profiles 244a, 244b are extruded onto the bases 249a, 249b, the complete zipper tape sections 296a, 296b are cooled on the casting roller 272 and thereafter removed from the casting roller 272. The zipper tape sections 296a, 296b may be utilized further downstream from the casting roller 272, or stored, either separately or combined, for later use. In another embodiment of a zipper tape apparatus (not shown) the bases 249a, 249b could be extruded as a single piece that preferably includes opposing bases 249a, 249b and includes a connection piece between the overlap portions 286a, 286b. However, other arrangements can be within the scope of the present invention.

### Industrial Applicability

The methods and apparatus described herein advantageously allow the user of this invention a simple and cost effective manner by which to produce bags having a thicker tops then bag walls. This type of bag is highly preferred by consumers and thus demand is high for this type of bag. This invention enables the user to convert production lines that had been producing a uniform thickness bag into a line producing bags with thickened top portions. Furthermore, this invention enables the user to produce zipper tape on those same lines without further modification, but by simply removing the film supply. One advantage of this invention is that it only requires the addition of two small base extrusion dies to upgrade a line compared to the much greater cost of an entire film with thicker top die that would be much larger. Also, this invention allows the use of a pre-extruded film thus allowing film to be produced on higher speed lines before hand. The partial overlap design also allows the inclusion of gripper ribs directly in the bases thus giving the user of a bag produced by these methods a firm gripping surface.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out the same. The exclusive rights to all modifications that come within the scope of the appended claims are reserved.

I claim:

1. A method of preparing a film for use in forming a storage bag, the method comprising the steps of:
supplying a pre-extruded thermoplastic film, the film having opposite first and second edge portions;
extruding a first base onto the first edge, wherein the first base partially overlaps the first edge; and
extruding a first profile onto the first base.

2. The method of claim 1, further including the steps of:
extruding a second base onto the second edge, wherein the second base at least partially overlaps the edge opposite the first base; and
extruding a second profile onto the second base.

3. The method of claim 2, further including the step of pinning the first base and second base onto the film.

4. The method of claim 3, wherein the step of pinning is accomplished before the steps of extruding the first profile onto the first base and extruding the second profile onto the second base.

5. The method of claim 3, wherein the pinning is accomplished through the use of an air knife.

6. The method of claim 3, wherein the pinning is accomplished through the use of a water jet.

7. The method of claim 1, wherein the overlap between the first base and the first edge is at least approximately 0.0625 inch (1.5875 mm).

8. The method of claim 1, wherein the overlap between the first base and the first edge is approximately 0.125 inch (3.175 mm).

9. The method of claim 1, wherein the steps of extruding the base and extruding the profile are completed on a single casting roller.

10. The method of claim 1 wherein the step of extruding the base occurs on a first casting roller and the step of extruding the profile occurs on a second casting roll downstream of the first casting roller

11. The method of claim 2, wherein at least one of the first and second bases further includes at least one gripping rib disposed parallel to and in a spaced apart relationship with the profile attached to the at least one of the first and second bases.

12. The method of claim 11, wherein the first and second profiles are extruded onto a first side of the first and second bases, respectively, and wherein the at least one gripping rib extends outwardly from the first side of the at least one of the first and second bases.

13. The method of claim 2, wherein both of the first and second bases further include at least one gripping rib disposed parallel to and in spaced apart relationship with the first and second profiles, respectively.

14 The method of claim 13, wherein the first and second profiles are extruded onto a first side of the first and second bases, respectively, and wherein the at least one gripping rib extends outwardly from the first side of the first and second bases, respectively.

15. The method of claim 2, wherein the film, first and second bases, and first and second profiles are made of thermoplastic.

16. The method of claim 2, wherein the four extruding steps are completed on a single casting roll.

17. A method of preparing a film for use in forming a storage bag, the method comprising the steps of:
supplying a film having opposite first and second edges onto a casting roll;
extruding a first base member onto the film, wherein the first base member partially overlaps the first edge of the film;
extruding a second base member onto the film, wherein the second base member partially overlaps the second edge of the film;
extruding a male closure profile onto the first base member; and
extruding a female closure profile onto the second base member.

18. The method of claim 17, wherein the steps of extruding the first base member and extruding the second base member occur substantially simultaneously.

19. The method of claim 17, wherein the steps of extruding a male closure profile and extruding a female closure profile occur substantially simultaneously.

20. The method of claim 17, wherein the step of supplying is accomplished by the steps of:
extruding the film downstream of the casting roller; and
transferring the film to the casting roller.

21. The method of claim 17, wherein the step of supplying is accomplished by utilizing a roll of pre-extruded film.

22. The method of claim 17, wherein the overlap between the first edge and the first base and the overlap between the second edge and the second base are at least approximately 0.0625 inch (1.5875 mm).

23. The method of claim 17, wherein the overlap between the first edge and the first base and the overlap between the second edge and the second base are approximately 0.125 inch (3.175 mm).

24. The method of claim 17, wherein the first base, second base, male closure profile and female closure profile are extruded onto the film while the film is on the casting roll.

25. The method of claim 17, further including the step of pinning the first base and second base to the film.

26. The method of claim 25, wherein the step of pinning is accomplished by an air knife.

27. The method of claim 25, wherein the step of pinning is accomplished by a water jet.

28. The method of claim 25, wherein the step of pinning occurs prior to the steps of extruding the male closure profile and extruding the female closure profile.

29. A storage bag produced by a method comprising the steps of:
supplying a film onto a casting roll wherein the film includes opposite first and second edges;
forming first and second bases onto the casting roll while the film is in contact with the casting roll, wherein the first and second bases partially overlap the first and second edges, respectively;
forming first and second closure profiles on the first and second bases, respectively, while the bases and film are in contact with the casting roll; and
converting the film into individual storage bags.

30. The storage bag produced by the method of claim 29, further including the step of pinning the first and second bases to the film.

31. The storage bag produced by the method of claim 29, further including the step of controlling the temperature of the casting roll.

32. The storage bag produced by the method of claim 29, wherein the step of forming the bases onto the casting roll comprises the step of extruding the bases.

33. The storage bag produced by the method of claim 29, wherein the step of forming the closure profiles onto the bases comprises the step of extruding the closure profiles.

34. The storage bag produced by the method of claim 29, wherein the overlap between the bases and the film is at least approximately 0.0625 inch (1.5875 mm).

35. The storage bag produced by the method of claim 29, wherein the overlap between the bases and the film is approximately 0.125 inch (3.175 mm).

36. An apparatus for producing thermoplastic storage bags, the apparatus comprising:
a casting roll;
a feeding mechanism to supply a bag film to the casting roll; and
an extrusion apparatus for extruding a pair of bases partially overlapping the film on the casting roll, the extrusion apparatus further extruding a closure profile onto the bases while the bases are on the casting roll.

37. The apparatus of claim 36, wherein the extrusion apparatus includes first, second, third, and fourth extrusion dies.

38. The apparatus of claim 36, further including a means for pinning the overlapping bases to the film.

39. The apparatus of claim 38, wherein the means for pinning comprises an air knife.

40. The apparatus of claim 38, wherein the means for pinning comprises a water jet.

41. The apparatus of claim 36, wherein the extrusion apparatus is disposed to create an overlap of at least approximately 0.0625 inch (1.5875 mm) between the bases and the film.

42. The apparatus of claim 36, wherein the extrusion apparatus is disposed to create an overlap of approximately 0.125 inch (3.175 mm) between the bases and the film.

43. The apparatus of claim 36, wherein the feeding mechanism includes a supply roller of film.

44. The apparatus of claim 43, wherein the feeding mechanism includes a pair of driven nip rollers for pulling the film from the supply roller.

45. The apparatus of claim 36, wherein the feeding mechanism includes a film extruder and means for forming and directing the extruded film to the casting roll.

46. A method of producing zipper tape, the method comprising:
extruding first and second bases onto a casting roll, the bases including a central thickened portion, an overlap portion extending from one side of the central portion and being thinner than the central portion, and a gripping portion extending from the side of the central portion opposite the overlap portion, the gripping portion including a plurality of gripping ribs extending from a side of the gripping portion opposite the casting roll; and
extruding male and female closure profiles onto the central portions of the first and second bases respectively while the bases are in contact with the casting roll.

47. The method of claim 46, further including the step of pinning the bases onto the casting rolls.

48. The method of claim 47, wherein the step of pinning is accomplished by an air knife.

49. The method of claim 47, wherein the step of pinning is accomplished by a water jet.
